(19) United States
(12) Patent Application Publication
(10) Pub. No.: US 2005/0053103 A1
(43) Pub. Date: Mar. 10, 2005

(54) Seeking and tracking control for locking to transmision peak for a tunable laser

(76) Inventors: Jiann-Chang Lo, Cupertino, CA (US); Andrew Daiber, Emerald Hills, CA (US); Mark S. Rice, San Jose, CA (US); Rajesh K. Batra, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/659,958

(22) Filed: Sep. 10, 2003

(51) Int. Cl. H01S 3/10; H01S 3/13

(52) U.S. Cl. 372/20; 372/32

(57) ABSTRACT

A servo or control technique and apparatus for performing wavelength locking employs the phase-shift modulation scheme to adjust one or more optical elements in the laser cavity to lock the lasing frequency toward a desired channel frequency. A controller comprises a high bandwidth mode and a low bandwidth mode. When initially locking to a new channel, the high bandwidth controller mode may be used to supply more energy to drive an actuator to achieve faster seeking. When an error signal approaches within a pre-defined threshold of zero error, the controller may be switched to a lower bandwidth mode supplying less power to the actuator to softly approach the target frequency and avoid overshoot. The lower bandwidth controller mode may keep the noise level lower and provide better frequency tracking stability to the tunable laser.

### FIELD OF THE INVENTION

An embodiment of the present invention relates to lasers and, more particularly, to tunable lasers.

### BACKGROUND INFORMATION

Wavelength division multiplexing (WDM) is a technique used to transmit multiple channels of data simultaneously over the same optic fiber. At a transmitter end, different data channels are modulated using light having different wavelengths (colors) for each channel. The fiber can simultaneously carry multiple channels in this manner. At a receiving end, these multiplexed channels may be easily separated prior to demodulation using appropriate wavelength filtering techniques.

The need to transmit greater amounts of data over a fiber has led to so-called Dense Wavelength Division Multiplexing (DWDM). DWDM involves packing additional channels into a given bandwidth space. The resultant narrower spacing between adjacent channels in DWDM systems demands precision wavelength accuracy from the transmitting laser diodes.

Tunable lasers offer a flexible and cost-effective option for use in optical networking applications. A single tunable laser may replace anyone of hundreds of fixed wavelength lasers in a DWDM link and therefore offer a significant opportunity for cost reduction. They further allow precise control over the wavelength separation between lasers in the array. The ability to tune the lasing frequency also relaxes fabrication tolerances and makes for robust laser components that may be tuned to compensate for ambient temperature changes and drift due to the effects of aging. Tunable lasers further offer the advantage of permitting flexible network management as well as lending themselves well to reconfiguration. This lends to a more efficient bandwidth usage that can be readily adaptable to new customer services.

There is an increasing demand for tunable lasers for test and measurement uses, wavelength characterization of optical components, fiber optic networks and other applications. In dense wavelength division multiplexing (DWDM) fiber optic systems, multiple separate data streams propagate concurrently in a single optical fiber, with each data stream created by the modulated output of a laser at a specific channel frequency or wavelength. Presently, channel separations of approximately 0.4 nanometers in wavelength, or about 50 GHz are achievable, which allows up to 128 channels to be carried by a single fiber within the bandwidth range of currently available fibers and fiber amplifiers. Greater bandwidth requirements will likely result in smaller channel separation in the future.

DWDM systems have largely been based on distributed feedback (DFB) lasers operating with a reference etalon associated in a feedback control loop, with the reference etalon defining the International Telecommunication Union (ITU) wavelength grid. Statistical variation associated with the manufacture of individual DFB lasers results in a distribution of channel center wavelengths across the wavelength grid, and thus individual DFB transmitters are usable only for a single channel or a small number of adjacent channels.

Continuously tunable external cavity lasers have been developed to overcome the limitations of individual DFB devices. Various laser-tuning mechanisms have been developed to provide external cavity wavelength selection, such as mechanically tuned gratings used in transmission and reflection. External cavity lasers should be able to provide a stable, single mode output at selectable wavelengths while effectively suppress lasing associated with external cavity modes that are within the gain bandwidth of the cavity. These goals have been difficult to achieve, and there is accordingly a need for an external cavity laser that provides stable, single mode operation at selectable wavelengths.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a generalized embodiment of an external cavity diode laser (ECDL);

FIG. 2 is a diagram illustrating the effect modulating the optical path length of an ECDL laser cavity has on the frequency of the lasing mode and the modulation of the laser's output intensity;

FIG. 3 is a diagram illustrating how a modulated excitation input signal and a resulting response output signal can be combined to calculate a demodulated error signal;

FIG. 4 is a schematic diagram of an ECDL in accordance with an embodiment of the invention in which a Lithium Niobate block is employed as an optical path length adjustment element;

FIG. 5 is a diagram of the time response of a cavity locking process for a tunable laser having a single mode bandwidth controller; and

FIG. 6 is a diagram of a cavity locking process of a tunable laser having a multiple bandwidth mode controller according to embodiments of the invention.

### DETAILED DESCRIPTION

Embodiments of a servo or control technique and apparatus for performing wavelength locking that locks cavity length of an external cavity diode laser (ECDL) during a channel change are disclosed. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

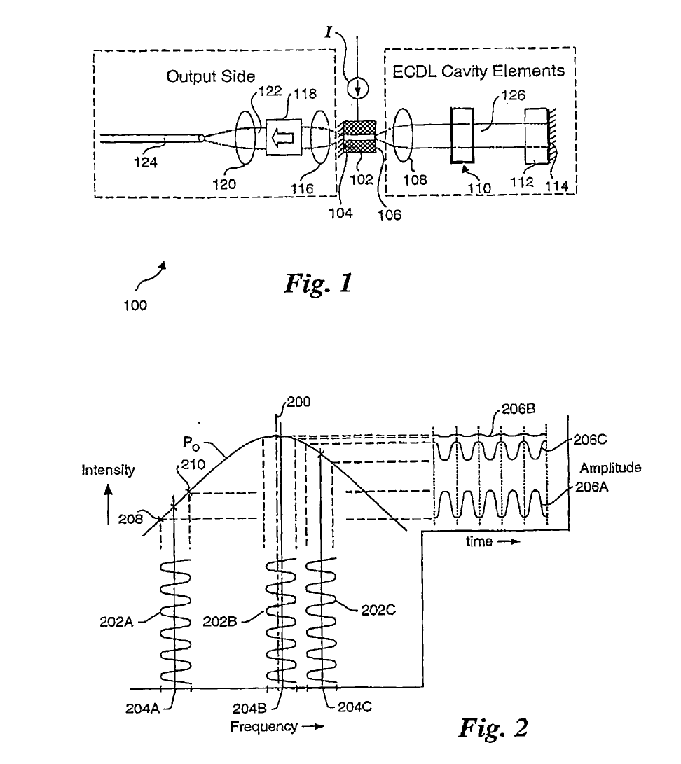

As an overview, a generalized embodiment of an ECDL 100 that may be used to implement aspects of the invention described below is shown in FIG. 1. ECDL 100 includes a gain medium comprising a diode gain chip 102. Diode gain chip 102 comprises a Fabry-Perot diode laser including a partially-reflective front facet 104 and a substantially non-reflective rear facet 106 coated with an anti-reflective (AR) coating to minimize reflections at its face. Optionally, diode gain chip 102 may comprise a bent-waveguide structure on the gain medium to realize the non-reflective rear facet 106. The external cavity elements include a diode intracavity collimating lens 108, tuning filter elements 110, a cavity-length modulating element 112, and a reflective element 114. In general, reflective element 114 may comprise a mirror, grating, prism, or other reflector or retroreflector which may also provide the tuning filter function in place of element 110. The output side components include a diode output collimating lens 116, an optical isolator 118, and a fiber focusing lens 120, which focuses an output optical beam 122 such that it is launched into an output fiber 124.

The basic operation of ECDL 100 is a follows. A controllable current I is supplied to diode gain chip 102 (the gain medium), resulting in a voltage differential across the diode junction, which produces an emission of optical energy (photons). The emitted photons pass back and forth between partially-reflective front facet 104 and reflective element 114, which collectively define the ends of the laser cavity. As the photons pass back and forth, a plurality of resonances, or “lasing” modes are produced. Under a lasing mode, a portion of the optical energy (photons) temporarily occupies the external laser cavity, as depicted by intracavity optical beam 126; at the same time, a portion of the photons in the external laser cavity eventually passes through partially-reflective front facet 104.

Light comprising the photons that exit the laser cavity through partially-reflective front facet 104 passes through diode output collimating lens 116, which collimates the light into output beam 122. The output beam then passes through optical isolator 118. The optical isolator is employed to prevent back-reflected light from being passed back into the external laser cavity, and is generally an optional element. After the light beam passes through the optical isolator, it is launched into the output fiber 124 by fiber focusing lens 120. Generally output fiber 124 may comprise a polarization-preserving type or a single-mode type such as SMF-28.

Through appropriate modulation of the input current (generally for communication rates of up to 2.5 GHz) or through modulation of an external element disposed in the optical path of the output beam (not shown) (for 10 GHz and 40 GHz communication rates), data can be modulated on the output beam to produce an optical data signal. Such a signal may launched into a fiber and transmitted over a fiber-based network in accordance with practices well known in the optical communication arts, thereby providing very high bandwidth communication capabilities.

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter elements 110, and cavity-length modulating element 112, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium.

As discussed above, under a lasing mode, photons pass back and forth between the cavity end reflectors at a resonance frequency, which is a function of the cavity optical path length. In fact, without the tuning filter elements, the laser would resonate at multiple frequencies. For simplicity, if we model the external laser as a Fabry-Perot cavity, these frequencies can be determined from the following equation:

$$Cl = \frac{λ x}{2 n} \qquad ( 1 )$$

where λ=wavelength, Cl=Length of the cavity, x=an arbitrary integer—1, 2, 3, . . . , and n=refractive index of the medium. The number of resonant frequencies is determined from the width of the gain spectrum. Furthermore, the gain spectrum is generally shaped as a parabola with a central peak—thus, the intensity of the lasing modes on the sides of the center wavelength (commonly called the side modes) rapidly drops off.

As describe below in further detail, various techniques may be applied to “tune” the laser to produce an optical output signal at a frequency corresponding to a desired communication channel. For example, this may be accomplished by adjusting one or more tuning elements, such as tuning filter elements 110, to produce a corresponding change in the cavity optical path length, thus changing the lasing mode frequency. The tuning filter elements attenuate the unwanted lasing modes such that the output beam comprises substantially coherent light having a narrow bandwidth.

Ideally, it is desired to maximize the power of the output beam over a frequency range corresponding to the various channel frequencies the ECDL is designed for. While an obvious solution might be to simply provide more drive current, this, by itself, doesn't work because a change in the drive current changes the optical characteristics (e.g., optical path length) of the diode gain chip. Furthermore, many diode gain chips only operate over a limited range of input current.

In accordance with aspects of the invention, one technique for producing a maximal power output is to perform “wavelength locking” through phase control modulation. Under this technique, a “dither” or modulation signal is supplied to cause a corresponding modulation in the optical path length of the laser cavity. This produces a modulated phase-shift effect, resulting in a small frequency modulation of the lasing mode. The result of this frequency modulation produces a corresponding modulation of the intensity (power) of the output beam, also referred to as amplitude modulation. This amplitude modulation can be detected using various techniques. In one embodiment, the laser diode junction voltage (the voltage differential across laser diode chip 102) is monitored while supplying a constant current to the laser diode, wherein the voltage is inversely proportional to the intensity of the output beam, e.g., a minimum measured diode junction voltage corresponds to a maximum output intensity. In another embodiment, a beam splitter is employed to split off a portion of the output beam such that the intensity of the split-off portion can be measured by a photo-electric device, such as a photodiode. The intensity measured by the photodiode is proportional to the intensity of the output beam. The measured amplitude modulation may then be used to generate a demodulated error signal that is fed back into a servo control loop to adjust the (substantially) continuous optical path length of the laser so as to produce maximal intensity.

The foregoing scheme is schematically illustrated in FIG. 2. The diagram shows a power output curve (PO) that is illustrative of a typical power output curve that results when the lasing mode is close to a desired channel, which is indicated by a channel frequency centerline 200. The objective of a servo loop that employs the phase-shift modulation scheme is to adjust one or more optical elements in the laser cavity such that lasing frequency is shifted toward the desired channel frequency. This is achieved through use of a demodulated error signal that results from frequency modulation of the lasing mode. Under the technique, a modulation signal is supplied to an optical element in the cavity, such as optical length modulation element 112, to modulate the optical path length of the cavity. This modulation is relatively small compared to the channel spacing for the laser. For example, in one embodiment the modulation may have an excursion of 4 MHz, while the channel spacing is 50 GHz.

Modulated signals 202A, 202B, and 202C respectively correspond to (average) laser frequencies 204A, 204B, and 204C. Laser frequency 204A is less than the desired channel frequency, laser frequency 204C is higher than the desired channel frequency, while 204B is near the desired channel frequency. Each modulated signal produces a respective modulation in the intensity of the output beam; these intensity modulations are respectively shown as modulated amplitude waveforms 206A, 206B, and 206C. Generally, the intensity modulations can be measured in the manners discussed above for determining the intensity of the output beam.

As depicted in FIG. 2, the peak to valley amplitude of waveforms 206A, 206B, and 206C is directly tied to the points in which the modulation limits for their corresponding frequency modulated signals 202A, 202B, and 202C intersect with power output curve PO, such as depicted by intersection points 208 and 210 for modulated signal 202A. Thus, as the laser frequency gets closer to the desired channel frequency, the peak to valley amplitude of the measured intensity of the output beam decreases. At the point where the laser frequency and the channel frequency coincide, this value becomes minimized.

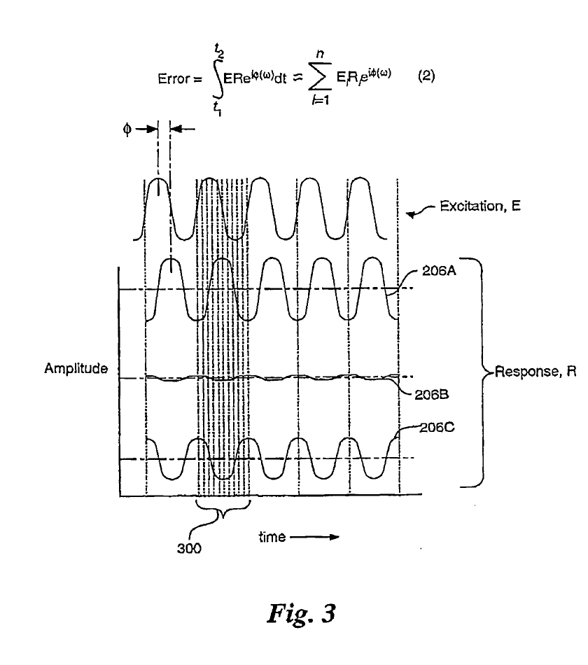

Furthermore, as shown in FIG. 3, the cavity length error may be derived from:

$$Error = {\int }_{{t}_{1}}^{{t}_{2}} E R {ⅇ}^{i ϕ ( ω )} ⅆ t \approx {\sum }_{i = 1}^{n} {E}_{i} {R}_{i} {ⅇ}^{ⅈ ϕ ( ω )} \qquad ( 2 )$$

wherein the non-italicized i is the imaginary number, φ represents the phase difference between the excitation input (i.e., modulated signals 202A, 202B, and 202C) and the response output comprising the amplitude modulated output waveforms 206A, 206B, and 206C, and ω is the frequency of modulation. The integral solution can be accurately approximated by a discreet time sampling scheme typical of digital servo loops of the type described below, as depicted by time sample marks 300.

In addition to providing an error amplitude, the foregoing scheme also provides an error direction. For example, when the laser frequency is in error on one side of the desired channel frequency (lower in the illustrated example), the excitation and response waveforms will be substantially in phase. This will produce a positive aggregated error value. In contrast, when the laser frequency is on the other side of the desired channel frequency (higher in the example), the excitation and response waveforms are substantially out of phase. As a result, the aggregated error value will be negative.

Generally, the wavelength locking frequency of modulation ω should be selected to be several orders of magnitude below the laser frequency. For example, modulation frequencies within the range of 500 Hz -100 kHz may be used in one embodiment with a laser frequency of 185-199 THz.

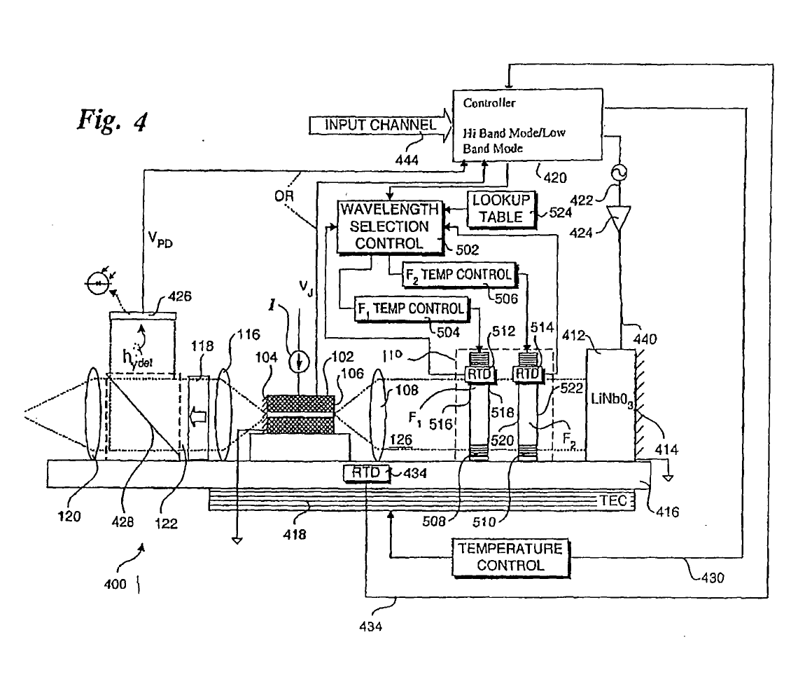

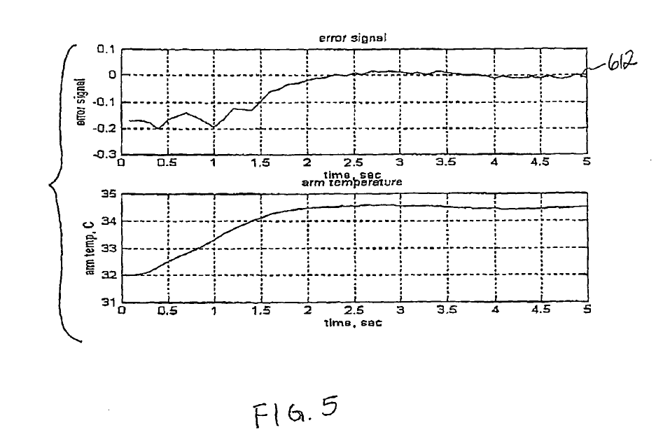

In FIG. 4, an ECDL 400 is shown including various elements common to ECDL 100 having like reference numbers, such as a gain diode chip 102, lenses 108, 116, and 120, etc. A channel selection subsystem may include a wavelength selection control block 502. It is noted that although the wavelength selection control block is shown external to controller 420, the control aspects of this block may be provided by the controller 420 alone. Wavelength selection control block 502 provides electrical outputs 504 and 506 for controlling the temperatures of filters F1 and F2, respectively. In one embodiment, temperature control element is disposed around the perimeter of a circular etalon, as depicted by TECs 508 and 510. Heaters imbedded inside of the filters may also be used to control etalon temperature. Respective RTDs 512 and 514 are employed to provide a temperature feedback signal back to wavelength selection control block 502.

Generally, etalons are employed in laser cavities to provide filtering functions. They function as Fabry-Perot resonators. The result of passing an optical beam through an etalon produces a set of transmission peaks (also called passbands) in the laser output. The spacing of the transmission peaks (in frequency, also known as the free spectral range) is dependent on the distance between the two faces of the etalon, e.g., faces 516 and 518 for filter F1, and faces 520 and 522 for filter F2. As the temperatures of the etalons change, the etalon material is caused to expand or contract, thus causing the distance between the faces to change. This effectively changes the optical path length of the etalons, which may be employed to shift the transmission peaks.

The effect of the filters is cumulative. As a result, all lasing modes except for a selected channel lasing mode can be substantially attenuated by lining up a single transmission peak of each filter. In one embodiment, the configurations of the two etalons are selected such that the respective free spectral ranges of the etalons are slightly different. This enables transmission peaks to be aligned under a Vernier tuning technique similar to that employed by a Vernier scale. In one embodiment, one of the filters, known as a “grid generator,” is configured to have a free spectral range corresponding to a communications channel grid, such as the ITU wavelength grid, and the peaks are aligned with ITU channel frequencies. This wavelength grid remains substantially fixed by maintaining the temperature of the corresponding grid generator etalon at a predetermined temperature. At the same time, the temperature of the other etalon, known as the channel selector, is adjusted so as to shift its transmission peaks relative to those of the grid generator. By shifting the transmission peaks of the filters in this manner, transmission peaks corresponding to channel frequencies may be aligned, thereby producing a cavity lasing mode corresponding to the selected channel frequency. In another embodiment, the transmission peaks of both the filters are shifted to select a channel.

Generally, either of these schemes may be implemented by using a channel-etalon filter temperature lookup table in which etalon temperatures for corresponding channels are stored, as depicted by lookup table 524. Typically, the etalon temperature/channel values in the lookup table may be obtained through a calibration procedure, through statistical data, or calculated based on tuning functions fit to the tuning data. In response to an input channel selection 444, the corresponding etalon temperatures are retrieved from lookup table 524 and employed as target temperatures for the etalons using appropriate temperature control loops, which are well-known in the art.

ECDL 400 may further include a cavity optical path length modulating element 412 having a reflective rear face 414. More specifically, the cavity optical path length modulating element comprises a Lithium Niobate (LiNbO3) phase modulator to which a back-side mirror is coupled. Optionally, a reflective material may be coated onto the backside of the phase modulator. Lithium Niobate is a material that changes its index of refraction (ratio of the speed of light through the material divided by the speed of light through a vacuum) when a voltage is applied across it. As a result, by providing a modulated voltage signal across the LiNbO3 phase modulator, the optical path length of the external laser cavity can be caused to modulate or “dithered”, thereby producing frequency modulated signals such as signals 202A, 202B, and 202C discussed above.

The various optical components of the ECDL 400 are mounted or otherwise coupled to a thermally-controllable base or “sled” 416. In one embodiment, one or more thermal-electric cooler (TEC) elements 418, such as a Peltier element, are mounted on or integrated in sled 416 such that the temperature of the sled can be precisely controlled via an input electrical signal. Due to the expansion and contraction of a material in response to a temperature change, the length of the sled can be adjusted very precisely. Adjustment of the length results in a change in the distance between partially reflective front facet 104 and reflective element 414, which produces a change in the optical path length of the laser cavity. As a result, controlling the temperature of the sled can be used to adjust the frequency of the lasing mode. In general, temperature control of the sled will be used for very fine tuning adjustments, while coarser tuning adjustments will be made by means of tuning filter elements 110, as described in further detail below.

For wavelength-locking, a controller 420 generates a modulated or “dithered” wavelength-locking signal 422, which is amplified by an amplifier 424. For example, in one embodiment modulated wavelength locking signal 422 may comprise a sinewave having a constant frequency, such as a 2-volt peak-to-peak signal with a frequency of about 889 Hz. The amplified modulated wavelength locking signal is then supplied to a surface of the LiNbO3 phase modulator 412, while an opposite surface is connected to ground, thereby providing a voltage differential across the LiNbO3 material. As a result, the optical path length of the modulator, and thus the entire laser cavity, is modulated at the modulation frequency (e.g. 889 Hz). In one embodiment, the 2-volt peak-to-peak voltage differential results in a frequency excursion of approximately 4 MHz.

This path length modulation produces a modulation in the intensity of output beam 122, which in one embodiment is detected by a photodetector 426. As depicted in FIG. 4, a beam splitter 428 is disposed in the optical path of output beam 122, causing a portion of the output beam light to be directed toward photodetector 426. In one embodiment, photodetector 426 comprises a photo diode, which generates a voltage charge in response to the light intensity it receives (hvdet). A corresponding voltage V_{PD} is then fed back to controller 420. In an optional embodiment, the junction voltage across gain diode chip (V_{J}) is employed as the intensity feedback signal, rather than V_{PD}. A cavity length error signal as discussed previously with reference to FIG. 3 is then derived based on the amplitude modulation and phase of V_{PD} or V_{J} in combination with modulated wavelength locking signal 422.

Controller 420 includes a digital servo loop that is configured to adjust the temperature of sled 416 such that the cavity length error signal is minimized, in accordance with the frequency modulation scheme discussed above with reference to FIGS. 2 and 3. In response to the error signal, an appropriate adjustment in temperature control signal 430 is generated. Adjustment of the sled temperature causes a corresponding change in the overall cavity length, and thus the lasing frequency. This in turn results in (ideally) a decrease in the difference between the lasing frequency and the desired channel frequency, thus completing the control loop. To reach an initial condition, or for controlling sled temperature, a resistive thermal device (RTD) 434, or a thermister or thermocouple, may be used to provide a temperature feedback signal 434 to controller 420.

When tuning a tunable laser to a target frequency (i.e., a new channel), both the tuning speed and frequency stability are very important to the operation. Embodiments of the invention provide a solution to improve both the speed and frequency stability.

When initially tuning the ECDL 400 to a new frequency (channel), the cavity length is on either side of the hill (P_{O}) as shown in FIG. 2 and moves to reach to the peak of the transmission curve. According to an embodiment, the controller 420 comprises high bandwidth mode and low bandwidth mode. During this initial time period, the high bandwidth controller mode may be used to supply more energy to an actuator, such as the sled TEC 418 to achieve higher speed seeking. When the cavity length error signal approaches within a pre-defined threshold, the controller may be switched to a lower bandwidth controller mode to approach the target (peak of the transmission curve) and to maintain locking at the peak. In this tracking mode, the lower bandwidth controller is able to keep the noise level lower and provides better frequency stability to the tunable laser.

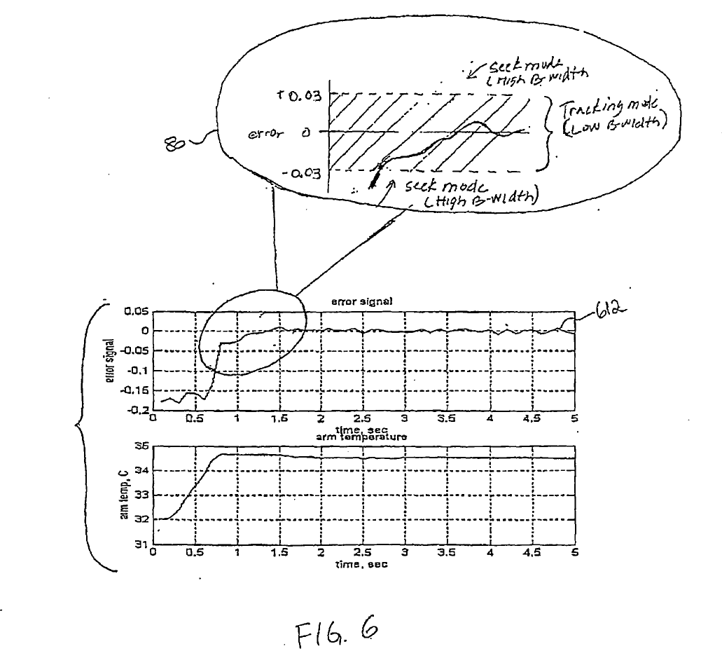

Improvements gleaned by using a variable bandwidth controller are demonstrated by comparing the time response diagrams shown in FIGS. 5 and 6. FIG. 5 is an example of a trace of cavity locking process and illustrates the case when a single bandwidth controller is used. The top graph of FIG. 5 plots the error signal 612 against time during the cavity locking process. The zero point of the error signal corresponds to the peak of the transmission curve. The bottom graph in FIG. 5 shows the temperature of the TEC 418 that controls the length of the cavity of a tunable laser. As shown, using a single bandwidth mode controller the target is eventually reached with the error signal kept relatively close to zero. In this example, it takes about 3 second to servo to the target.

FIG. 6 illustrates the case where a variable bandwidth controller is used and shows the trace of cavity locking process according to embodiments of the invention. In the seeking stage, the higher bandwidth mode of controller 420 allows the sled TEC 418 temperature to rise very quickly. However, as shown in the exploded view 80, when the error signal is just approaching zero, the controller 420 switches to a tracking mode using a lower bandwidth filter or mode such that a zero error signal is approached softly avoiding overshoot of the target frequency. Moreover, in steady state, frequency stability of the tunable laser may be improved with the error signal kept very close to zero when in the tracking mode using a lower bandwidth controller. In this example, the controller 420 is in a seeking mode when the absolute value of the error signal is greater than about 0.03 and switches to a tracking mode when the error signal is within a threshold range of +/−0.03. Of course this is by way of example only as the range may be greater or narrower depending on the application and the operating tolerances of the laser. The multiple mode controller 420 may be realized by any of a number of controller schemes such as a lead/lag controller or PID (Proportional Integral Derivative) controller. In seeking mode a Bang-Bang or similar open loop controller may also be used. When in the seeking mode the controller 420 in high bandwidth mode may use greater power to drive the TEC 418, for example the drive power may be about 2 or 3 watts, and in the tracking mode the controller in a lower bandwidth mode may decrease the power to drive the TEC 418 with, for example about 0.1-0.2 watts.

As shown in FIG. 6, using the two-mode controller, it only takes about 1.7 second to lock the same tunable laser as in FIG. 5 to the same frequency. Thus, by using a two-mode controller one does not have to compromise between speed and frequency stability of a tunable laser. Hence, both seeking and tracking servo may be optimized simultaneously greatly improving the performance of a tunable laser.

While embodiments have been described in terms of a cavity locking servo of a tunable laser, the described techniques may also be used in the temperature control of the etalons of tunable filters (F1 and F2 of FIG. 4). The temperature control of etalons in the tunable laser is used to move the transmission curve to a desired frequency. This technique can also be applied to all other type of tunable laser that uses different types of actuators to tune to a requested frequency.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A tunable laser, comprising:
an actuator to drive a tuning element of a tunable laser;
a multiple bandwidth mode controller comprising a high bandwidth mode and a lower bandwidth mode,
said controller to initially drive said actuator in said high bandwidth mode and switch to said lower bandwidth mode when an error signal associated with a target frequency is within a threshold range.

2. The tunable laser as recited in claim 1, wherein said tuning element comprises a thermo electric cooler (TEC).

3. The tunable laser as recited in claim 1 wherein said tuning element comprises one of etalons and filters.

4. The tunable laser as recited in claim 1 wherein said high bandwidth mode drives said actuator with a first power level and said lower bandwidth mode drives said actuator with a second power level, said first power level greater than said second power level.

5. The tunable laser as recited in claim 4 wherein said first power level comprises higher power and said second power level comprises lower power.

6. The tunable laser as recited in claim 4 wherein said error signal is derived from a dither signal to an optical path length modulating element.

7. The tunable laser as recited in claim 6 wherein said optical path length modulating element comprises a Lithium Niobate (LiNbO₃) phase modulator.

8. The tunable laser as recited in claim 1 wherein said controller in said high bandwidth mode comprises a Bang Bang controller or an open loop controller.

9. The tunable laser as recited in claim 1 wherein said controller comprises one of a lead/lag controller and a Proportional Integral Derivative (PID) controller.

10. A method of tuning a laser, comprising:
dithering a cavity length of said laser to produce a transmission peak error signal for a target frequency;
driving an actuator at a first power level to move said error signal towards zero;
driving said actuator at a second power level, less than said first power level, when said error signal is with a threshold range near zero.

11. The method as recited in claim 10 wherein said dithering comprises supplying a voltage signal to a phase modulator to modulate a cavity length of said laser.

12. The method as recited in claim 11 wherein said voltage signal comprises about a sinewave signal at a constant frequency.

13. The method as recited in claim 10 wherein driving said actuator comprises changing a temperature of a thermoelectric cooler (TEC).

14. The method as recited in claim 10 wherein driving said actuator comprises tuning one of an etalon or a filter.

15. A system, comprising:
an external cavity diode laser (ECDL);
an actuator to drive a tuning element of said ECDL;
a multiple bandwidth mode controller comprising a high bandwidth mode for seeking a new target frequency and a lower bandwidth mode for tracking the target frequency,
said controller to initially drive said actuator in said high bandwidth mode and then in said lower bandwidth mode when an error signal associated with a target frequency is within a threshold range.

16. The system as recited in claim 15, wherein said tuning element comprises a thermo electric cooler (TEC).

17. The system as recited in claim 15 wherein said tuning element comprises one of etalons and filters.

18. The system as recited in claim 15 wherein said high bandwidth mode drives said actuator with a first power level and said lower bandwidth mode drives said actuator with a second power level, said first power level greater than said second power level.

19. The system as recited in claim 18 wherein said first power level comprises a higher power and said second power level comprises a lower power.

20. The system as recited in claim 15 wherein said error signal is derived from a dither signal to an optical path length modulating element.

21. The system as recited in claim 20 wherein said optical path length modulating element comprises a Lithium Niobate (LiNbO₃) phase modulator.

22. The system as recited in claim 15 wherein said controller comprises a Bang-Bang controller or other open loop controller in said high bandwidth mode.

23. The system as recited in claim 15 wherein said controller comprises one of a lead/lag controller and a Proportional Integral Derivative (PID) controller.
